(19) United States
(12) Patent Application Publication
(10) Pub. No.: US 2014/0099624 A1
(43) Pub. Date: Apr. 10, 2014

(54) MENTOR-TUNED GUIDED LEARNING IN ONLINE EDUCATIONAL SYSTEMS

(71) Applicant: AGE OF LEARNING, INC., (US)

(72) Inventors: Doug Dohring, Glendale, CA (US); William McCaffrey, Glendale, CA (US); Stephanie Yost, Glendale, CA (US); David Hendry, La Crescenta, CA (US); Lee Borth, Sunland, CA (US); Nathan Drobnack, Glendale, CA (US)

(73) Assignee: AGE OF LEARNING, INC., Glendale, CA (US)

(21) Appl. No.: 13/827,566

(22) Filed: Mar. 14, 2013

Related U.S. Application Data
(60) Provisional application No. 61/647,989, filed on May 16, 2012.

(51) Int. Cl. G09B 7/00

(52) U.S. Cl. CPC G09B 7/00
USPC 434/350

(57) ABSTRACT

Computer-based systems, methods, media, and educational system assembling platforms comprising an educational environment which further comprises: at least one area of skill, interest, or expertise; a population of learning activities associated with each area of skill, interest, or expertise; and a guided learning mode comprising: a software module configured to display and provide access to one or more subpopulations of learning activities to be completed by a learner; a software module configured to suggest or recommend one or more particular learning activities to a learner based on analysis of learner data; and a software module configured to allow a mentor to view and tune learner data on which suggestions or recommendations are based.

### CROSS-REFERENCE TO RELATED APPLICATIONS

This application claims the benefit of U.S. Application Ser. No. 61/647,989, filed May 16, 2012, which is hereby incorporated by reference in its entirety.

### BACKGROUND OF THE INVENTION

Higher levels of education offer benefits, both intangible and economic, for students and the societies in which they live. Personal benefits can include a feeling of fulfillment, social and economic mobility, and increased quality of life. According to the Census Bureau, over an adult's working life, high school graduates earn an average of $1.2 million; associate's degree holders earn about $1.6 million; and bachelor's degree holders earn about $2.1 million. On a larger scale, countries with high enrollment and graduation rates have grown faster than countries without.

Effective educational experiences are important at all stages of life. Preschool education develops the foundation for children's enduring language, motor, and analytical skills. Primary education helps children achieve basic literacy and numeracy, and establishes foundations in science, mathematics, geography, history, and other social sciences. Secondary education provides adolescents opportunities to learn in areas beyond traditional basic subjects including foreign languages, advanced math, advanced science, and advanced humanities. Importantly, secondary education also prepares students for the transition to higher education as adults. Higher education provides specialized academic, professional, or vocational training, resulting in award of certificates, diplomas, or academic degrees. In professional life, education enables adults to advance within their career or re-train to support a career change. Even in post-career life, seniors enjoy the benefits of education in pursuit of hobbies and personal interests.

Educational subjects and the reasons for undertaking education vary greatly at different stages of life. Moreover, every individual learns differently. Therefore, effective educational experiences should provide every learner with opportunities to interact with customized learning content. In educational environments, mentors provide expertise to less experienced individuals to help them enhance their learning. Mentors can provide the insight necessary to customize learning content to meet the needs of individual learners.

### SUMMARY OF THE INVENTION

Technology offers educators new opportunities to create powerful learning tools. For example, multimedia provides new ways to interact with learners, such as interactive online educational environments. In such an environment, mentors can be provided with tools to leverage their experience and knowledge of each learner in order to customize the educational experience. All learners need not experience identical sequences of learning activities. For these reasons, an effective educational environment should provide features and functionality that allow mentors to bring their experience and knowledge of each learner to bear in the design of customized lessons, units, and levels of study.

Despite the potential for customized content and mentor involvement in structuring learning content created by technology, current online educational environments offer little opportunity for customization and just as little opportunity for mentor involvement. Accordingly, we have identified a long-felt and unmet need for an online educational environment that offers a mentor guided learning mode. Such a mode should provide features and functionality to enable mentors to select one or more learners, select learning activities from among a population to create one or more subpopulations of activities, display one or more subpopulations of activities to learners and provide them access to the learning activities. And, in some embodiments, the mode should allow mentors and learners to monitor the progress of learners as they complete activities and subpopulations of activities.

In one aspect, disclosed herein are educational system assembling platforms comprising: a digital processing device comprising a memory and an operating system configured to perform executable instructions; a computer program, provided to the digital processing device, including executable instructions that create an educational environment, the educational environment comprising: at least one area of skill, interest, or expertise; a population of learning activities associated with each area of skill, interest, or expertise; and a guided learning mode comprising: a software module configured to display and provide a learner access to one or more subpopulations of learning activities to be completed by a learner; a database of learner data in a computer memory; a software module configured to suggest or recommend one or more particular learning activities to a learner based on analysis of the learner data; and a software module configured to allow a mentor to view and tune learner data on which suggestions or recommendations are based. In some embodiments, the guided learning mode further comprises a software module, adapted for a mentor, for selecting one or more learners. In further embodiments, the software module configured to allow a mentor to view and tune learner data on which suggestions or recommendations are based allows a mentor to score, rate, or rank subjects, skills, educational objectives, or learning activities for suggestion or recommendation. In further embodiments, the guided learning mode further comprises a software module, adapted for a mentor, configured to allow selection of learning activities from among the population of activities to create one or more subpopulations of activities to be completed by a learner. In some embodiments, the software module configured to suggest or recommend one or more particular learning activities to a learner generates a character-based guide to make suggestions or recommendations. In some embodiments, the guided learning mode further comprises a software module configured to track and store learner data associated with learner interactions with the educational environment.

In another aspect, disclosed herein are non-transitory computer-readable storage media encoded with a computer program including instructions executable by a processor to create an educational system assembling platform, the platform comprising: at least one area of skill, interest, or expertise; a population of learning activities associated with each area of skill, interest, or expertise; and a guided learning mode comprising: a software module configured to display and provide a learner access to one or more subpopulations of learning activities to be completed by a learner; a database of learner data in a computer memory; a software module configured to suggest or recommend one or more particular learning activities to a learner based on analysis of the learner data; and a software module configured to allow a mentor to view and tune learner data on which suggestions or recommendations are based. In some embodiments, the guided learning mode further comprises a software module, adapted for a mentor, for selecting one or more learners. In further embodiments, the software module configured to allow a mentor to view and tune learner data on which suggestions or recommendations are based allows a mentor to score, rate, or rank subjects, skills, educational objectives, or learning activities for suggestion or recommendation. In further embodiments, the guided learning mode further comprises a software module, adapted for a mentor, configured to allow selection of learning activities from among the population of activities to create one or more subpopulations of activities to be completed by a learner. In some embodiments, the software module configured to suggest or recommend one or more particular learning activities to a learner generates a character-based guide to make suggestions or recommendations. In some embodiments, the guided learning mode further comprises a software module configured to track and store learner data associated with learner interactions with the educational environment.

In another aspect, disclosed herein are computer-implemented methods of educating a learner in a guided learning mode comprising the steps of: providing, by a computer, a population of learning activities associated with an area of skill, interest, or expertise; providing, by the computer, a software module configured to display and provide the learner access to one or more subpopulations of learning activities to be completed by the learner; providing, by the computer, a database of learner data; providing, by the computer, a software module configured to suggest or recommend one or more particular learning activities to a learner based on analysis of the learner data; and providing, by the computer, a software module configured to allow a mentor to view and tune learner data on which suggestions or recommendations are based. In some embodiments, the method further comprises the step of providing, by the computer, a software module, adapted for a mentor, for selecting one or more learners. In further embodiments, wherein the software module configured to allow a mentor to view and tune learner data on which suggestions or recommendations are based allows a mentor to score, rate, or rank subjects, skills, educational objectives, or learning activities for suggestion or recommendation. In further embodiments, wherein the method further comprises the step of providing, by the computer, a software module, adapted for a mentor, configured to allow selection of learning activities from among the population of activities to create one or more subpopulations of activities to be completed by a learner. In some embodiments, the software module configured to suggest or recommend one or more particular learning activities to a learner generates a character-based guide to make suggestions or recommendations. In some embodiments, the method further comprises the step of providing, by the computer, a software module configured to track and store learner data associated with learner interactions with the educational environment.

Also disclosed herein, in certain embodiments, are computer-based educational system assembling platforms, methods of education, and media encoded with computer programs. In some embodiments, the computer-based educational system assembling platforms are intranet-based. In some embodiments, the assembling platforms are Internet-based. In further embodiments, the assembling platforms are World Wide Web-based. In still further embodiments, the assembling platforms are cloud computing-based. In other embodiments, the assembling platforms are based on data storage devices including, by way of non-limiting examples, CD-ROMs, DVDs, flash memory devices, magnetic disk drives, and optical disk drives.

In some embodiments, the computer-based educational systems comprise a digital processing device connected to a computer network and a computer program including executable instructions that create an educational environment. In further embodiments, the digital processing device comprises an operating system configured to perform executable instructions, a central processing unit, a memory device, a display, a sound output device, and an input device. In some embodiments, the computer program includes executable instructions that create an educational environment comprising at least one area of skill, interest, or expertise, and a plurality of activities associated with each area of skill, interest, or expertise. In some embodiments, the educational environment further comprises a mentor guided learning mode.

An aspect of the educational system assembling platforms disclosed herein is a software module, adapted for use by a mentor, for selecting one or more learners. In some embodiments, the mentor creates an account within the educational system. In further embodiments, a mentor associates one or more learners with their account. In some embodiments, a mentor selects one learner for whom to configure a customized sequence of learning activities. In further embodiments, a mentor selects more than one learner. In various embodiments, mentors can select learners in a multitude of ways. In some embodiments, a mentor selects one or more learners by selecting learners' names, selecting learners' avatars, or by typing learners' names. In some embodiments, a mentor selects one or more learners based on characteristics such as, previous completion of specific learning activities, performance in previous learning activities, or interests and preferences of the learners.

Another aspect of the educational system assembling platforms disclosed herein is a software module, adapted for use by a mentor, for selecting learning activities from among a population of activities to create one or more subpopulations of activities to be completed by one or more learners. In various embodiments, mentors can identify learning activities in a multitude of ways. In some embodiments, the software module for selecting learning activities is configured to allow a mentor to identify activities by area of skill, interest, or expertise. In various embodiments, the software module for selecting learning activities is configured to allow a mentor to identify activities by activity type, activity theme, activity duration, or level of skill required. In some embodiments, the software module for selecting learning activities is configured to allow a mentor to identify activities that teach to a particular educational objective. In some embodiments, the software module for selecting learning activities is configured to allow a mentor to identify activities that teach to a particular element of a published educational standard. In further embodiments, the software module for selecting learning activities is configured to allow a mentor to identify activities by keyword searching. In various embodiments, mentors can select learning activities and add them to a subpopulation of activities in a multitude of ways such as clicking activity icons, dragging and dropping activity icons into a designated area, checking check boxes associated with activities, or typing the names of activities. In some embodiments, the educational system assembling platform further comprises a software module for creating, naming, and saving multiple subpopulations of learning activities associated with one or more learners. In some embodiments, the software module for selecting learning activities is configured to allow a mentor to remove one or more activities from a subpopulation of activities. In some embodiments, a mentor removes activities by dragging and dropping activity icons into a designated area. In some embodiments, the software module for selecting learning activities is configured to allow said mentor to block one or more activities to prevent a learner from accessing those activities.

In some embodiments, the educational system assembling platforms disclosed herein further comprise a software module, adapted for use by a mentor, for displaying and further organizing one or more subpopulations of learning activities. In some embodiments, the software module for displaying and organizing one or more subpopulations of learning activities is configured to allow said mentor to sort subpopulations of activities based on each activity's association with one or more areas of skill, interest, or expertise. In some embodiments, the software module for displaying and organizing one or more subpopulations of learning activities is configured to allow said mentor to sort subpopulations of activities based on the degree to which each activity teaches to a particular educational objective. In some embodiments, the software module for displaying and organizing one or more subpopulations of learning activities is configured to allow said mentor to sort subpopulations of activities based on the degree to which each activity addresses a particular element of a published educational standard. In some embodiments, the software module is configured to allow said mentor to sequence, rank, or prioritize activities within subpopulations of activities. In various embodiments, mentors can sequence learning activities in a multitude of ways such as dragging and dropping activity icons, typing a number associated with each activity, or using a pull down menu to assign a number. In some embodiments, the software module for displaying and organizing one or more subpopulations of learning activities is configured to allow said mentor to remove activities from subpopulations of activities. In further embodiments, a mentor removes activities by dragging and dropping them into a designated area. In some embodiments, the software module for displaying and organizing one or more subpopulations of learning activities is configured to display the number of times said learner has completed each activity.

Another aspect of the educational system assembling platforms disclosed herein is a software module, adapted for use by a learner, for displaying and providing access to one or more subpopulations of learning activities to be completed by a learner. In some embodiments, the software module for displaying and providing access to one or more subpopulations of learning activities displays a single subpopulation of activities. In other embodiments, the software module displays more than one subpopulation of activities. In further embodiments, the software module displays a list of named subpopulations of activities. In some embodiments, the software module for displaying and providing access to one or more subpopulations of learning activities is configured to allow a learner to sort subpopulations of activities based on each activity's association with one or more areas of skill, interest, or expertise. In some embodiments, the software module for displaying and providing access to one or more subpopulations of learning activities is configured to allow a learner to sort subpopulations of activities based on the degree to which each activity teaches to a particular educational objective. In some embodiments, the software module for displaying and providing access to one or more subpopulations of learning activities is configured to allow a learner to sort subpopulations of activities based on the degree to which each activity addresses a particular element of a published educational standard. In some embodiments, the software module for displaying and providing access to one or more subpopulations of learning activities is configured to allow a learner to freely select learning activities from among subpopulations of activities. In other embodiments, the software module is configured to require learners to complete a subpopulation of learning activities in the sequence determined by said mentor. In either configuration, in some embodiments, a learner has the option to repeat previously completed learning activities. In various embodiments, learners can select learning activities and access them in a multitude of ways such as clicking activity icons, double-clicking activity icons, hovering a pointer over activity icons, dragging and dropping activity icons, or typing the names of activities. In some embodiments, the software module for displaying and providing access to one or more subpopulations of learning activities is configured to display the number of times a learner has completed each activity. In some embodiments, the software module for displaying and providing access to one or more subpopulations of learning activities is configured to allow a learner to optionally remove learning activities from subpopulations of activities. In further embodiments, a learner may optionally remove learning activities from subpopulations based on criteria such as each activity's association with one or more areas of skill, interest, or expertise, activity type, or activity theme.

In some embodiments, the educational system assembling platforms disclosed herein further comprise a software module, adapted for use by a mentor, for monitoring the progress of a learner in completing one or more subpopulations of activities. In some embodiments, the software module for monitoring the progress of a learner in completing one or more subpopulations of activities includes a visual indicator adapted for use by a learner, wherein said visual indicator displays the percentage of activities completed within a subpopulation of activities. In various embodiments, the visual indicator is in the form of a bar chart, pie chart, or a numeric percentage. In some embodiments, the software module for monitoring the progress of a learner in completing one or more subpopulations of activities includes progress displays adapted for use by a learner or a mentor to a learner. In further embodiments, the progress displays indicate metrics such as percentage completion of one or more subpopulations of activities, performance in one or more subpopulations of activities, and time spent in one or more subpopulations of activities. In still further embodiments, the progress displays indicate metrics such as completion of each activity associated with each subpopulation of activities, performance in each activity associated with each subpopulation of activities, and time spent in each activity associated with each subpopulation of activities. In still further embodiments, the progress displays indicate completion of one or more subpopulations of activities that teach to a particular educational objective, performance in one or more subpopulations of activities that teach to a particular educational objective, and time spent in one or more subpopulations of activities that teach to a particular educational objective. In still further embodiments, the progress displays indicate completion of one or more subpopulations of activities that address a particular element of a published educational standard, performance in one or more subpopulations of activities that address a particular element of an educational standard, and time spent in one or more subpopulations of activities that address a particular element of a published educational standard. In some embodiments, the software module for monitoring the progress of a learner in completing one or more subpopulations of activities includes printable reports adapted for use by a learner or a mentor to a learner.

### BRIEF DESCRIPTION OF THE DRAWINGS

FIG. 1 shows a feature for use by a mentor in creating customized learning content; in this case, a lesson builder providing functionality for selecting one or more learners 1, identifying learning activities by area of skill, interest, or expertise 2, identifying learning activities by activity type 3, identifying learning activities by keyword searching 4, adding learning activities to subpopulations by dragging activity icons 6 to a designated area 5, further organizing 7 subpopulations of activities, blocking activities by dragging activity icons to a designated area 8, and removing activities from subpopulations by dragging activity icons to a designated area 9.

FIG. 2 shows a feature for use by a mentor in displaying and organizing one or more subpopulations of learning activities; in this case, a feature providing functionality for sorting subpopulations of activities based on each activity's association with one or more areas of skill, interest, or expertise 10, 11, sequencing activities within subpopulations of activities by dragging and dropping activity icons 12, removing activities from subpopulations of activities 13, and displaying the number of times a learner has completed each activity with a numeric counter 14 and a graphic icon 15.

FIG. 3 shows a feature for displaying and providing access to one or more subpopulations of learning activities to be completed by a learner; in this case, a feature providing functionality for sorting subpopulations of activities based on each activity's association with one or more areas of skill, interest, or expertise 16, accessing learning activities by selectable activity icons 17, and displaying the number of times a learner has completed each activity with a numeric counter 18 and a graphic icon 19.

### DETAILED DESCRIPTION OF THE INVENTION

Existing educational systems do not offer learners adequate opportunities to benefit from customized learning content nor do they provide powerful tools to facilitate the involvement of mentors in the design of customized educational content. Thus, a primary objective of the educational system assembling platforms, methods of education, and media encoded with computer programs disclosed herein is to facilitate and enhance the education of learners by providing every learner with opportunities to interact with customized learning content. Another objective is to provide features and functionality that allow mentors to bring their experience and knowledge of each learner to bear in the design of customized lessons, units, and levels of study. Advantages include, but are not limited to, more immersive, customized educational experiences for learners and mentors who are enabled to inject the insight necessary to customize learning content to meet the needs of individual learners. Yet another objective is to provide an engaging mechanism to guide learner selection of learning activities. Further advantages include, but are not limited to, offering character-based guides that are empowered to recommend learning activities based on learner pattern analysis and/or mentor tuning.

Accordingly, disclosed herein, in certain embodiments, are educational system assembling platforms comprising: a digital processing device comprising a memory and an operating system configured to perform executable instructions; a computer program, provided to the digital processing device, including executable instructions that create an educational environment, the educational environment comprising: at least one area of skill, interest, or expertise; a population of learning activities associated with each area of skill, interest, or expertise; and a guided learning mode comprising: a software module configured to display and provide a learner access to one or more subpopulations of learning activities to be completed by a learner; a database of learner data in a computer memory; a software module configured to suggest or recommend one or more particular learning activities to a learner based on analysis of the learner data; and a software module configured to allow a mentor to view and tune learner data on which suggestions or recommendations are based.

Also disclosed herein, in certain embodiments, are non-transitory computer-readable storage media encoded with a computer program including instructions executable by a processor to create an educational system assembling platform, the platform comprising: at least one area of skill, interest, or expertise; a population of learning activities associated with each area of skill, interest, or expertise; and a guided learning mode comprising: a software module configured to display and provide a learner access to one or more subpopulations of learning activities to be completed by a learner; a database of learner data in a computer memory; a software module configured to suggest or recommend one or more particular learning activities to a learner based on analysis of the learner data; and a software module configured to allow a mentor to view and tune learner data on which suggestions or recommendations are based.

Also disclosed herein, in certain embodiments, are computer-implemented methods of educating a learner in a guided learning mode comprising the steps of: providing, by a computer, a population of learning activities associated with an area of skill, interest, or expertise; providing, by the computer, a software module configured to display and provide the learner access to one or more subpopulations of learning activities to be completed by the learner; providing, by the computer, a database of learner data; providing, by the computer, a software module configured to suggest or recommend one or more particular learning activities to a learner based on analysis of the learner data; and providing, by the computer, a software module configured to allow a mentor to view and tune learner data on which suggestions or recommendations are based.

### CERTAIN DEFINITIONS

The term “learner” as used herein, refers to a person of any age who interacts with an educational system for the purpose of gaining knowledge, insight, or understanding of one or more areas of skill, interest, or expertise or by virtue of having been allowed, asked, or assigned to interact with an educational system.

The term “mentor” as used herein, refers to a person who has an interest in, or responsibility for, facilitating or furthering the educational development of a learner and includes, by way of non-limiting examples, a parent, step-parent, adoptive parent, foster parent, grandparent, guardian, relative, friend, guide, instructor, teacher, or professor, of a learner.

The term “instructional designer” as used herein, refers to any person who designs and/or evaluates learning activities, and grouped sequences of activities, that are elements of an educational system.

The term “instructional plan” as used herein, refers to a plan, conceived by an instructional designer or a mentor to a learner, designed to accomplish one or more specific educational objectives through the mutual reinforcement of individual activities.

The term “lesson” as used herein, refers to one or more learning activities that teach toward a specific educational objective or a specific element of a published educational standard.

The term “learning unit” as used herein, refers to one or more lessons that teach toward a general educational objective or a general element of a published educational standard.

The term “level of study” as used herein, refers to one or more learning units that teach toward a plurality of general educational objectives or an overarching element of a published educational standard.

### Educational System Assembling Platform

Disclosed herein, in some embodiments, are educational system assembling platforms comprising a digital processing device optionally connected to a computer network and a computer program provided to the digital processing device via the network. In further embodiments, the digital processing device comprises an operating system configured to perform executable instructions, a central processing unit, a memory device, a display, an input device, and a sound output device. In still further embodiments, the computer program includes executable instructions that create an educational environment that comprises at least one area of skill, interest, or expertise, a population (e.g., a plurality) of learning activities associated with each area of skill, interest, or expertise, and a mentor guided learning mode. In some embodiments, the mentor guided learning mode comprises a software module, adapted for use by a mentor, for selecting one or more learners, a software module, adapted for use by a mentor, for selecting learning activities from among said population of activities to create one or more subpopulations of activities to be completed by a learner, and a software module, adapted for use by a learner, for displaying and providing access to one or more subpopulations of learning activities to be completed by a learner.

### Digital Processing Device

In some embodiments, the methods, systems, platforms, and media described herein include a digital processing device, or use of the same. In further embodiments, the digital processing device includes one or more hardware central processing units (CPU) that carry out the device's functions. In some embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to the learner. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes a sound output device to send auditory information to the learner. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

In some embodiments, the digital processing device includes an input device to receive information from the learner. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

### Areas of Skill, Interest, or Expertise

In some embodiments, the educational system assembling platforms disclosed herein include at least one area of skill, interest, or expertise. An area of skill, interest, or expertise may include informal topics such as those relating to hobbies and personal interests. A hobby is an activity or interest usually undertaken for pleasure or relaxation. An area of skill, interest, or expertise may also include more formal subjects addressing academic or professional topics. A subject is a category of learning that a student may typically undertake in an educational institution. In some embodiments, subjects comprise topics addressing one category of learning. In other embodiments, subjects comprise interdisciplinary topics addressing more than one category of learning. An area of skill, interest, or expertise may also include topics such as those relating to professional skills. Some professional skills are not taught as formal subjects, nor are they hobbies undertaken for relaxation, rather they are topics undertaken for business purposes.

In some embodiments, one or more areas of skill, interest, or expertise are selected from hobbies and personal interests including, by way of non-limiting examples, animal husbandry, animal breeding, antiquing, artistic endeavors, automobile restoration, automobile repair, bird watching, collecting, cooking, creating dioramas, fish keeping, fishing, flower arranging, game playing, gardening, horticulture, investing, knitting, origami, outdoor recreation, performing arts, poetry, quilting, reading, sewing, scale modeling, scrapbooking, wine tasting, writing, and yoga. In some embodiments, artistic endeavors include endeavors such as drawing, glass blowing, painting, sculpting, photography, and pottery. In some embodiments, collecting includes collecting art, coins, dolls, figurines, stamps, spoons, sports cards, and toys. In some embodiments, outdoor recreation includes activities such as backpacking, bicycling, canoeing, caving, climbing, hiking, running, snow sports, and water sports. In some embodiments, performing arts include activities such as acting, dancing, singing, juggling, magic, and playing musical instruments. In some embodiments, reading includes reading materials such as books, comics, magazines, and newspapers. In some embodiments, scale modeling includes subject matter such as automobiles, planes, ships, and trains.

In some embodiments, one or more areas of skill, interest, or expertise are selected from basic subjects including, by way of non-limiting examples, reading and mathematics. In further embodiments, the subjects include one or more basic topics including, by way of non-limiting examples, letters, phonics, word families, sight words, numbers, and shapes.

In some embodiments, one or more areas of skill, interest, or expertise are selected from preschool subjects including, by way of non-limiting examples, language arts, mathematics, social studies, science, music, art, and additional languages. In further embodiments, the subjects include one or more preschool topics including, by way of non-limiting examples, citizenship, colors, computer skills, drawing, ethics, geography, music, physical education, poetry, reading, sign language, Spanish, spelling, and U.S. history.

In some embodiments, one or more areas of skill, interest, or expertise are selected from grade school subjects including, by way of non-limiting examples, language arts, mathematics, social studies, science, music and other performing arts, visual arts, additional languages, health, fitness and sports, and information technology. In further embodiments, the subjects include one or more grade school topics including, by way of non-limiting examples, biology, chemistry, citizenship, composition, computer skills, drawing, earth science, ethics, geography, grammar, physical education, poetry, pre-algebra, reading, sign language, spelling, U.S. government, U.S. history, and writing.

In some embodiments, one or more areas of skill, interest, or expertise are selected from middle school subjects including, by way of non-limiting examples, language arts, mathematics, social studies, science, music and other performing arts, visual arts, additional languages, health, fitness and sports, and information technology. In further embodiments, the subjects include one or more middle school topics including, by way of non-limiting examples, algebra, American literature, biology, chemistry, composition, computer skills, drawing, earth science, ethics, geography, geometry, grammar, journalism, photography, physical education, poetry, pre-algebra, reading, spelling, U.S. government, U.S. history, world history, and writing.

In some embodiments, one or more areas of skill, interest, or expertise are selected from high school subjects including, by way of non-limiting examples, language arts, mathematics, social studies, science, music and other performing arts, visual arts, additional languages, health, fitness and sports, and information technology. In further embodiments, the subjects include one or more high school topics including, by way of non-limiting examples, U.S. history, U.S. government, world history, European history, economics, geography, psychology, sociology, anthropology, philosophy, biology, ecology, anatomy, physiology, chemistry, physics, earth science, astronomy, algebra, statistics, geometry, calculus, trigonometry, grammar, spelling, writing, American literature, European literature, English literature, world literature, composition, poetry, drawing, painting, photography, film, theatre, journalism, computer skills, computer science, computer programming, business, physical education, and sign language.

In some embodiments, one or more areas of skill, interest, or expertise are selected from higher education subjects including, by way of non-limiting examples, language arts, mathematics, social studies, science, music and other performing arts, visual arts, additional languages, health, fitness and sports, and information technology. In further embodiments, the subjects include one or more higher education topics including, by way of non-limiting examples, U.S. history, U.S. government, world history, European history, economics, macroeconomics, microeconomics, psychology, sociology, anthropology, philosophy, law, political science, education, urban studies, women's studies, biology, botany, ecology, environmental studies, anatomy, physiology, virology, pharmacology, cell biology, molecular biology, microbiology, genetics, medicine, neuroscience, chemistry, organic chemistry, biochemistry, physical chemistry, biophysics, physics, earth science, astronomy, astrophysics, algebra, statistics, geometry, calculus, trigonometry, electrical engineering, civil engineering, mechanical engineering, chemical engineering, writing, American literature, European literature, English literature, world literature, composition, poetry, music theory, religion, drawing, painting, photography, film, theatre, journalism, computer science, computer programming, business, business administration, accounting, nursing, law enforcement, physical education, and sign language.

In some embodiments, one or more areas of skill, interest, or expertise are selected from language arts topics including, by way of non-limiting examples, phonics, reading, vocabulary, spelling, grammar, writing, composition, public speaking, American literature, world literature, and poetry.

In some embodiments, one or more areas of skill, interest, or expertise are selected from mathematics topics including, by way of non-limiting examples, mathematics, algebra, geometry, calculus, trigonometry, probability, statistics, number theory, applied mathematics, logic, and topology.

In some embodiments, one or more areas of skill, interest, or expertise are selected from social studies topics including, by way of non-limiting examples, political science, law, U.S. government, U.S. history, world history, geography, economics, archaeology, anthropology, sociology, communication, and psychology.

In some embodiments, one or more areas of skill, interest, or expertise are selected from science topics including, by way of non-limiting examples, health, nutrition, biology, ecology, environmental science, meteorology, oceanography, marine biology, hydrology, soil science, botany, anatomy, physiology, virology, pharmacology, cell biology, molecular biology, microbiology, genetics, medicine, pathology, neuroscience, zoology, chemistry, organic chemistry, biochemistry, physical chemistry, materials science, biophysics, physics, optics, earth science, electrical engineering, civil engineering, mechanical engineering, chemical engineering, paleontology astronomy, astrophysics, and computer science.

In some embodiments, one or more areas of skill, interest, or expertise are selected from arts topics including, by way of non-limiting examples, writing, composition, poetry, art, music, music theory, drawing, painting, photography, film, theatre, dance, sculpture, and art history.

In some embodiments, one or more areas of skill, interest, or expertise are selected from languages including, by way of non-limiting examples, English, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, That, Burmese, Malay, Telugu, and Javanese.

In some embodiments, one or more areas of skill, interest, or expertise are selected from health, sports, and fitness topics including, by way of non-limiting examples, health, nutrition, physical education, archery, baseball, basketball, boating, bowling, cheerleading, cricket, cycling, field hockey, football, golf, hiking, ice hockey, lacrosse, martial arts, water polo, rock climbing, roller hockey, rugby, running, skiing, soccer, surfing, swimming, and walking.

In some embodiments, one or more areas of skill, interest, or expertise are selected from information technology topics including, by way of non-limiting examples, computer skills, Internet safety, computer programming, computer networking, and computer science.

In some embodiments, one or more areas of skill, interest, or expertise are selected from professional topics including, by way of non-limiting examples, continuing legal education, continuing medical education, and continuing education for teachers, accountants, tax preparers, physical therapists, occupational therapists, psychologists, nurses, and nurse practitioners.

In some embodiments, one or more areas of skill, interest, or expertise are selected from professional skills including, by way of non-limiting examples, organization, leadership, time management, negotiation, harassment awareness, conflict management, interviewing, and networking.

In some embodiments, one or more areas of skill, interest, or expertise comprise a plurality of levels. In further embodiments, each area of skill, interest, or expertise comprises a plurality of levels. In some of these embodiments, a level comprises educational topics and activities appropriate for a particular developmental stage of a learner. In some embodiments, a level comprises educational topics and activities appropriate for a particular skill level of a learner. In some embodiments, a level comprises educational topics and activities appropriate for a particular educational objective. In other embodiments, a level comprises educational topics and activities appropriate for a particular test or certification. In some of these embodiments, one or more areas of skill, interest, or expertise comprise three, four, five, six, seven, eight, nine, ten, eleven, twelve, or more levels. In one particular embodiment, one or more areas of skill, interest, or expertise comprise six levels. In some embodiments, each area of skill, interest, or expertise comprises three, four, five, six, seven, eight, nine, ten, eleven, twelve, or more levels. In another particular embodiment, each area of skill, interest, or expertise comprises six levels.

### Learning Activities

In some embodiments, the educational system assembling platforms disclosed herein include a population (e.g., a plurality) of learning activities associated with each area of skill, interest, or expertise. In some embodiments, each activity is substantially related to one or more specific areas of skill, interest, or expertise. In some embodiments, each activity teaches toward educational objectives within one or more specific areas of skill, interest, or expertise. In some embodiments, each learning activity in the plurality of learning activities associated with each area of skill, interest, or expertise requires a similar level of skill or knowledge to complete. In other embodiments, the learning activities in the plurality of learning activities associated with each area of skill, interest, or expertise require a range of levels of skill or knowledge to complete. In further embodiments, one or more learning activities requires a range of levels of skill or knowledge.

In further embodiments, the plurality of activities is interconnected by an instructional plan designed to accomplish one or more specific educational objectives through the mutual reinforcement of individual activities. In some embodiments, an instructional plan interconnects two or more activities associated with a subject in such a way that understanding is built progressively with one or more activities adding to the educational messages of one or more previous activities. In further embodiments, an instructional plan is conceived by an instructional designer. In other embodiments, an instructional plan is conceived by a mentor to a learner.

In some embodiments, one or more activities are selected from informal activities including, by way of non-limiting examples, demonstrations, how-to-articles, how-to-videos, and simulations.

In some embodiments, one or more activities are selected from preschool activities including, by way of non-limiting examples, books, games, puzzles, art, and music.

In some embodiments, one or more activities are selected from K-12 activities including, by way of non-limiting examples, books, games, puzzles, art, music, reading assignments, articles, videos, demonstrations, simulations, quizzes, examinations, worksheets, problem sets, brainstorms, and journals.

In some embodiments, one or more activities are selected from higher education activities including, by way of non-limiting examples, books, reading assignments, lectures, articles, videos, demonstrations, simulations, mock examinations, quizzes, examinations, essays, laboratory experiments, problem sets, brainstorms, and journals.

In some embodiments, one or more activities are selected from professional activities including, by way of non-limiting examples, books, articles, brainstorms, collaborations, group activities, multi-player games, videos, lectures, role-plays, simulations, demonstrations, quizzes, and exams.

In some embodiments, one or more activities are available in a language other than English in order to facilitate the education of non-English speaking learners. In other embodiments, one or more activities are available in a language other than English in order to address a language curriculum. In further embodiments, one or more activities are available in one or more languages including, by way of non-limiting examples, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, That, Burmese, Malay, Telugu, and Javanese.

### Selecting One or More Learners

In some embodiments, the educational system assembling platforms disclosed herein include a software module, adapted for use by a mentor, for selecting one or more learners. In view of the disclosure provided herein, the software module is created by techniques known to those of skill in the art using machines, software, and languages known to the art. In some embodiments, to use the software module for selecting one or more learners, a mentor creates an account within the educational system. In further embodiments, the mentor then associates one or more learners with the account. In some embodiments, the mentor associates learners with the account by typing information describing each learner. In other embodiments, the mentor associates learners with the account by uploading a data file containing information describing each learner. In further embodiments, the data file is formatted in a data serialization format known to those in the art including, by way of non-limiting examples, tab-separated values, comma-separated values, character-separated values, delimiter-separated values, XML, JSON, BSON, and YAML.

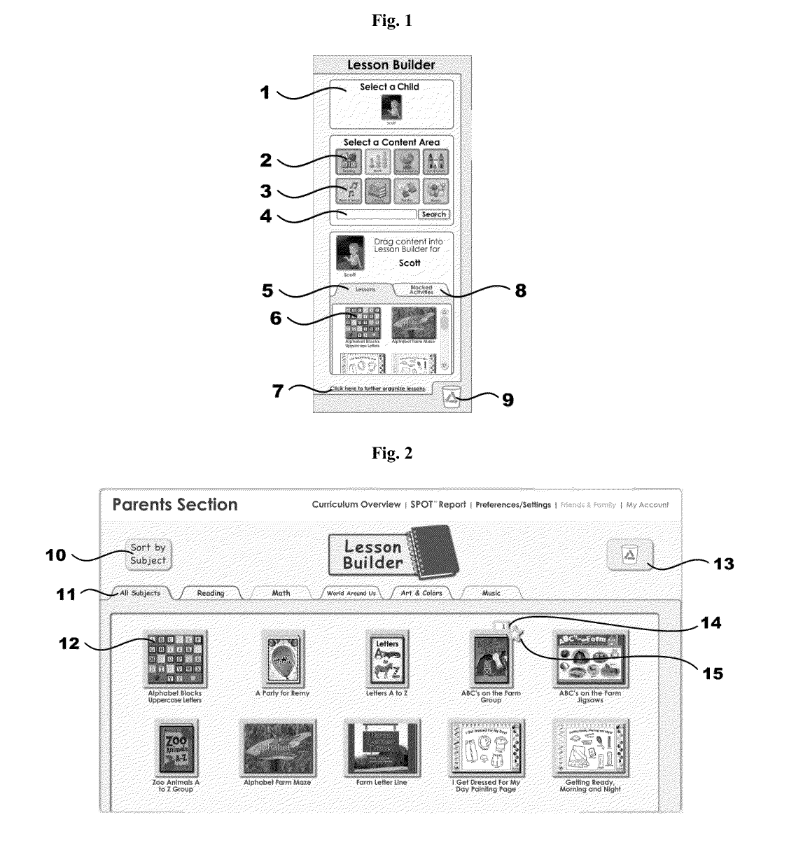

Referring to FIG. 1, in some embodiments, the mentor is presented with a list of learners 1 for whom the mentor may create a customized sequence of learning activities. In some embodiments, the list of learners comprises names of learners. In further embodiments, the list of learners further comprises icons, such as avatars, associated with learners. In further embodiments, the mentor may select one or more learners for whom the mentor may create a customized sequence of learning activities. In some embodiments, a mentor selects one or more learners based on characteristics such as, previous completion of specific learning activities, performance in previous learning activities, or interests and preferences of the learners.

In some embodiments, a mentor selects learners by selecting elements associated with the learners including, by way of non-limiting examples, text, icons, avatars, or check boxes. In some embodiments, a mentor selects elements associated with learners using a pointing device including, by way of non-limiting examples, a mouse, trackball, track pad, or stylus. In further embodiments, a mentor makes selections with a pointing device by actions including, by way of non-limiting examples, clicking, double clicking, right clicking, shift clicking, control clicking, command clicking, dragging, or drawing a line, circle, or other shape. In some embodiments, a mentor selects elements associated with learners using a touch screen or multi-touch screen. In further embodiments, a mentor makes selections with a touch screen or multi-touch screen by actions including, by way of non-limiting examples, tapping, double tapping, dragging, pinching, or drawing a line, circle, or other shape. In other embodiments, a mentor selects elements associated with learners using a microphone to capture voice or other sound input. In other embodiments, a mentor selects elements associated with activities using a video camera to capture motion or visual input. In some embodiments, a mentor selects learners using a keyboard, or alternative text input device, by typing names of learners or other text associated with learners.

### Selecting Learning Activities

In some embodiments, the educational system assembling platforms disclosed herein include a software module, adapted for use by a mentor, for selecting learning activities from among a population of activities to create one or more subpopulations of activities to be completed by a learner. In view of the disclosure provided herein, the software module is created by techniques known to those of skill in the art using machines, software, and languages known to the art. In some embodiments, the software module for selecting learning activities from among a population of activities to create one or more subpopulations of activities to be completed by a learner is available from every section of the educational environment such that a mentor may browse the environment and is free to select any learning activity.

Referring to FIG. 1, in some embodiments, the software module for selecting learning activities is configured to allow a mentor to identify activities by area of skill, interest, or expertise. In further embodiments, a mentor is presented with selectable elements representing groups of learning activities teaching toward learning objectives in one or more areas of skill, interest, or expertise 2. In some embodiments, areas of skill, interest, or expertise including, by way of non-limiting examples, hobbies and personal interests, basic subjects and topics, preschool subjects and topics, grade school subjects and topics, middle school subjects and topics, high school subjects and topics, higher education subjects and topics, language arts topics, mathematics topics, social studies topics, science topics, arts topics, languages, health, sports, and fitness topics, information technology topics, professional topics, and professional skills, described herein. In a particular embodiment, a mentor is presented with selectable elements representing groups of learning activities teaching toward learning objectives in reading, math, science and social studies, and art and colors.

Further referring to FIG. 1, in some embodiments, the software module for selecting learning activities is configured to allow a mentor to identify activities by activity type. In further embodiments, a mentor is presented with selectable elements representing types of activities 3. In some embodiments, activity types include, by way of non-limiting examples, informal activities, preschool activities, K-12 activities, higher education activities, and professional activities, described herein. In a particular embodiment, a mentor is presented with selectable elements representing types of learning activities including music and songs, books, puzzles, and games.

In some embodiments, the software module for selecting learning activities is configured to allow said mentor to identify activities by activity theme. In some embodiments, the software module for selecting learning activities is configured to allow a mentor to identify activities that teach to a particular educational objective. In some embodiments, the software module for selecting learning activities is configured to allow a mentor to identify activities that teach to a particular element of a published educational standard. In some embodiments, the said software module for selecting learning activities is configured to allow a mentor to identify activities by activity duration. In some embodiments, the software module for selecting learning activities is configured to allow a mentor to identify activities by activity level of skill required. In further embodiments, the software module for selecting learning activities is configured to allow a mentor to identify activities by combinations of the criteria described herein.

Referring to FIG. 1, in some embodiments, the software module for selecting learning activities is configured to allow a mentor to identify activities by keyword searching 4. In further embodiments, keywords relate to any of the criteria for identifying learning activities described herein.

In some embodiments, a mentor selects learning activities for inclusion in a subpopulation of activities to be completed by a learner by selecting elements associated with activities including, by way of non-limiting examples, text, icons, or check boxes. Referring to FIG. 1, in some embodiments, a mentor selects learning activities by dragging and dropping activity icons 6 into a designated area 5.

In some embodiments, a mentor selects elements associated with learning activities using a pointing device including, by way of non-limiting examples, a mouse, trackball, track pad, or stylus. In further embodiments, a mentor makes selections with a pointing device by actions including, by way of non-limiting examples, clicking, double clicking, right clicking, dragging, or drawing a line, circle, or other shape. In some embodiments, a mentor selects elements associated with activities using a touch screen or multi-touch screen. In further embodiments, a mentor makes selections with a touch screen or multi-touch screen by actions including, by way of non-limiting examples, tapping, double tapping, dragging, pinching, or drawing a line, circle, or other shape. In other embodiments, a mentor selects elements associated with activities using a microphone to capture voice or other sound input. In other embodiments, a mentor selects elements associated with activities using a video camera to capture motion or visual input. In some embodiments, a mentor selects activities using a keyboard, or alternative text input device, by typing names of activities or other text associated with activities.

In some embodiments, the software module for selecting learning activities is configured to allow a mentor to block one or more activities such that it cannot be accessed by one or more learners. In some embodiments, a mentor selects learning activities for blocking by selecting elements associated with activities including, by way of non-limiting examples, text, icons, or check boxes. Referring to FIG. 1, in some embodiments, a mentor selects learning activities for blocking by dragging and dropping activity icons 6 into a designated area 8. In some embodiments, a mentor selects learning activities for blocking by any of the selection methods described herein.

In some embodiments, the software module for selecting learning activities is configured to allow a mentor to remove one or more activities from a subpopulation of activities. In some embodiments, a mentor selects learning activities for removal from a subpopulation of activities to be completed by a learner by selecting elements associated with activities including, by way of non-limiting examples, text, icons, or check boxes. Referring to FIG. 1, in some embodiments, a mentor removes learning activities by dragging and dropping activity icons 6 into a designated area 9. In some embodiments, a mentor selects learning activities for removal by any of the selection methods described herein. In further embodiments, a mentor removes learning activities by other methods including, by way of non-limiting examples, using a right click menu, unchecking a check box, or using the delete key on a keyboard.

### Subpopulations of Activities

In some embodiments, the educational system assembling platforms disclosed herein include a software module, adapted for use by a mentor, for creating, naming, and saving multiple subpopulations of learning activities associated with one or more learners. In view of the disclosure provided herein, the software module is created by techniques known to those of skill in the art using machines, software, and languages known to the art. In some embodiments, a mentor creates one subpopulation of learning activities from the population (e.g., plurality) of activities. In some embodiments, a mentor creates more than one subpopulation of learning activities from the population of activities. In further embodiments, a mentor creates 2, 3, 4, 5, 6, 7, 8, 9, 10, 11, 12, 13, 14, 15, 16, 17, 18, 19, 20, 21, 22, 23, 24, 25 or more subpopulations of learning activities from the population of activities. In some embodiments, subpopulations of learning activities are associated with one learner. In other embodiments, subpopulations of learning activities are associated with more than one learner. In further embodiments, subpopulations of learning activities are associated with a class of learners. In some embodiments, a subpopulation of activities comprises activities within a lesson. In some embodiments, a subpopulation of activities comprises lessons within a unit. In some embodiments, a subpopulation of activities comprises units in a level of study. In further embodiments, a subpopulation of activities comprises a combination of activities, lessons, and units.

### Organizing Subpopulations of Activities

Referring to FIG. 1, in some embodiments, the educational system assembling platforms disclosed herein provide a mentor access to a software module to further organize subpopulations of learning activities to be completed by a learner 7. In some embodiments, the educational system assembling platforms disclosed herein include a software module, adapted for use by a mentor, for displaying and organizing one or more subpopulations of learning activities. In view of the disclosure provided herein, the software module is created by techniques known to those of skill in the art using machines, software, and languages known to the art.

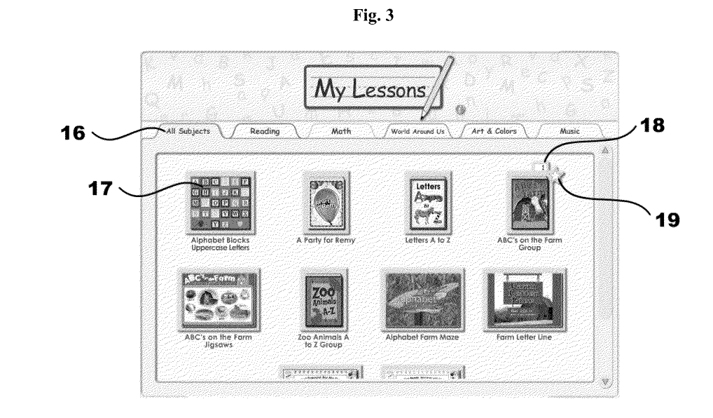

Referring to FIG. 2, in some embodiments, the software module for displaying and organizing one or more subpopulations of learning activities is configured to allow a mentor to sort subpopulations of activities based on each activity's association with one or more areas of skill, interest, or expertise. In further embodiments, a mentor may use a selectable element 10 to activate tabs 11 labeled with one or more areas of skill, interest, or expertise. In still further embodiments, each tab 11 provides access to learning activities within one or more subpopulations of activities associated with an area of skill, interest, or expertise.

In some embodiments, the software module for displaying and organizing one or more subpopulations of learning activities is configured to allow a mentor to sort subpopulations of activities based on the degree to which each activity teaches to a particular educational objective. In some embodiments, the software module for displaying and organizing one or more subpopulations of learning activities is configured to allow a mentor to sort subpopulations of activities based on the degree to which each activity addresses a particular element of a published educational standard.

In some embodiments, the software module for displaying and organizing one or more subpopulations of learning activities is configured to allow a mentor to sequence activities within subpopulations of activities. In some embodiments, the software module for displaying and organizing one or more subpopulations of learning activities is configured to allow a mentor to sequence learning activities within lessons. In some embodiments, the software module for displaying and organizing one or more subpopulations of learning activities is configured to allow a mentor to sequence lessons within learning units. In some embodiments, the software module for displaying and organizing one or more subpopulations of learning activities is configured to allow a mentor to sequence learning units within levels of study. In some embodiments, the software module for displaying and organizing one or more subpopulations of learning activities is configured to allow a mentor to rank or prioritize activities within subpopulations of activities.

In some embodiments, each step in the sequence activities within a subpopulation of activities comprises either an activity or a set of alternate activities. In further embodiments, where the next step in a sequence of activities is a singular activity, the educational system presents the activity to the learner. In further embodiments, where the next step in a sequence of activities is a set of alternate activities, the educational system presents one activity from the set of alternate activities to the learner. In some embodiments, the educational system presents an activity from a set of alternate activities based on, by way of non-limiting examples, the skill level of the learner, the performance of the learner in previously completed activities, input of a mentor to the learner, or the preference of the learner.

Referring to FIG. 2, in some embodiments, a mentor sequences, ranks, or prioritizes learning activities within a subpopulation of activities to be completed by a learner by dragging and dropping activity icons 12 into a spatial order relative to each other. In further embodiments, a mentor sequences, ranks, or prioritizes learning activities within a subpopulation of activities by assigning a number using techniques including, by way of non-limiting examples, typing numbers, using a pull down menu, using a slider control, and using radio buttons.

In some embodiments, the software module for displaying and organizing one or more subpopulations of learning activities is configured to allow said mentor to remove activities from subpopulations of activities. In some embodiments, a mentor selects learning activities for removal from a subpopulation of activities to be completed by a learner by selecting elements associated with activities including, by way of non-limiting examples, text, icons, or check boxes. Referring to FIG. 2, in some embodiments, a mentor removes learning activities by dragging and dropping activity icons 12 into a designated area 13. In some embodiments, a mentor selects learning activities for removal by any of the selection methods described herein. In further embodiments, a mentor removes learning activities by other methods including, by way of non-limiting examples, using a right click menu, unchecking a check box, or using the delete key on a keyboard.

In some embodiments, the software module for displaying and organizing one or more subpopulations of learning activities is configured to display the number of times a learner has completed one or more activities. In some embodiments, the number of times a learner has completed an activity is represented as, by way of non-limiting examples, a number, a percentage, a pie chart, a bar chart, a color, a shade, dots, checkmarks, or variations in size.

Referring to FIG. 2, in some embodiments, the software module for displaying and organizing one or more subpopulations of learning activities is configured to further display a numeric counter 14 indicating number of times a learner has completed each activity. In a particular embodiment, a white star 15 indicates that a learner has completed an activity more than once, but less than five times. In a particular embodiment, a gold star indicates that a learner has completed an activity more than five times. In other embodiments, the software module for displaying and organizing one or more subpopulations of learning activities is configured to display a Boolean indicator of whether or not a learner has completed each activity. In further embodiments, a Boolean indicator is represented as, by way of non-limiting examples, a color, dot, checkmark, outline, border, or size.

### Providing Access to Subpopulations of Activities

In some embodiments, the educational system assembling platforms disclosed herein include a software module, adapted for use by a learner, for displaying and providing access to one or more subpopulations of learning activities to be completed by a learner. In view of the disclosure provided herein, the software module is created by techniques known to those of skill in the art using machines, software, and languages known to the art.

Referring to FIG. 3, in some embodiments, the software module for displaying and providing access to one or more subpopulations of learning activities is configured to allow a learner to sort subpopulations of activities based on each activity's association with one or more areas of skill, interest, or expertise. In further embodiments, a learner may use tabs 16 labeled with one or more areas of skill, interest, or expertise. In still further embodiments, each tab 16 provides access to learning activities within one or more subpopulations of activities associated with an area of skill, interest, or expertise.

In some embodiments, the software module for displaying and providing access to one or more subpopulations of learning activities is configured to allow a learner to sort subpopulations of activities based on the degree to which each activity teaches to a particular educational objective. In some embodiments, the software module for displaying and providing access to one or more subpopulations of learning activities is configured to allow a learner to sort subpopulations of activities based on the degree to which each activity addresses a particular element of a published educational standard.

In some embodiments, the software module for displaying and providing access to one or more subpopulations of learning activities is configured to allow said learner to freely select learning activities from among subpopulations of activities. In further embodiments, a learner has the option to repeat previously completed learning activities. Referring to FIG. 3, in some embodiments, a learner selects learning activities by selecting activity icons associated with learning activities 17.

In further embodiments, a learner selects elements associated with learning activities using a pointing device including, by way of non-limiting examples, a mouse, trackball, track pad, or stylus. In further embodiments, a learner makes selections with a pointing device by actions including, by way of non-limiting examples, clicking, double clicking, right clicking, dragging, or drawing a line, circle, or other shape. In some embodiments, a learner selects elements associated with activities using a touch screen or multi-touch screen. In further embodiments, a learner makes selections with a touch screen or multi-touch screen by actions including, by way of non-limiting examples, tapping, double tapping, dragging, pinching, or drawing a line, circle, or other shape. In other embodiments, a learner selects elements associated with activities using a microphone to capture voice or other sound input. In other embodiments, a learner selects elements associated with activities using a video camera to capture motion or visual input. In some embodiments, a learner selects activities using a keyboard, or alternative text input device, by typing names of activities or other text associated with activities.

In some embodiments, the software module for displaying and providing access to one or more subpopulations of learning activities is configured to require a learner to complete a subpopulation of learning activities in the sequence determined by a mentor. In such embodiments, a learner must complete each preceding activity in the sequence to progress to the next activity. Typically, a mentor selects a sequence of activities such that each activity can build on the educational messages of those prior toward the goal of providing a learner understanding of one or more areas of skill, interest, or expertise. In some embodiments, the sequence of activities is predetermined to prepare a learner for a particular certification or examination. In other embodiments, the sequence of activities is predetermined in accordance with a published educational standard. In further embodiments, a learner has the option to repeat previously completed learning activities without progressing to the next activity in the sequence.

In some embodiments, the software module for displaying and providing access to one or more subpopulations of learning activities is configured to display the number of times said learner has completed each activity. In some embodiments, the number of times a learner has completed an activity is represented as, by way of non-limiting examples, a number, a percentage, a pie chart, a bar chart, a color, a shade, dots, checkmarks, or variations in size.

Referring to FIG. 3, in some embodiments, the software module for displaying and providing access to one or more subpopulations of learning activities is configured to further display a numeric counter 18 indicating number of times a learner has completed each activity. In a particular embodiment, a white star 19 indicates that a learner has completed an activity more than once, but less than five times. In a particular embodiment, a gold star indicates that a learner has completed an activity more than five times. In other embodiments, the software module for displaying and organizing one or more subpopulations of learning activities is configured to display a Boolean indicator of whether or not a learner has completed each activity. In further embodiments, a Boolean indicator is represented as, by way of non-limiting examples, a color, dot, checkmark, outline, border, or size.

In some embodiments, the software module for displaying and providing access to one or more subpopulations of learning activities is configured to allow a learner to optionally remove learning activities from subpopulations of activities based on each activity's association with one or more areas of skill, interest, or expertise. In some embodiments, the software module is configured to allow said learner to optionally remove learning activities from subpopulations of activities based on activity type. In some embodiments, the software module is configured to allow said learner to optionally remove learning activities from subpopulations of activities based on activity theme.

### Character-Based Guides

In some embodiments, the software module for displaying and organizing one or more subpopulations of learning activities is configured to allow a mentor to sequence activities within subpopulations of activities. In further embodiments, the software module for displaying and organizing one or more subpopulations of learning activities is configured to allow a mentor to rank or prioritize activities within subpopulations of activities. Accordingly, in some embodiments, the software module for displaying and providing access to one or more subpopulations of learning activities is configured to require a learner to complete a subpopulation of learning activities in the sequence determined by a mentor.

However, in alternative embodiments, the software module for displaying and providing access to one or more subpopulations of learning activities is configured to allow a learner to freely select learning activities from among subpopulations of activities. Additionally, in some embodiments, a mentor configures a sequence within a subpopulation of activities where each step in the sequence comprises a set of alternate activities. In such embodiments, a learner selects learning activities from among a set of alternate activities.

In various embodiments wherein a learner selects learning activities in which to participate, the educational system assembling platforms disclosed herein include a software module configured to suggest or recommend one or more particular learning activities to a learner. Many formats are suitable for providing a learner with a suggestion or a recommendation including, by way of non-limiting examples, text, images, audio, video, animation, and multimedia, including combinations thereof. In some embodiments, a software module configured to suggest or recommend one or more particular learning activities to a learner makes a suggestion or a recommendation via a character that serves as an engaging site ambassador. In further embodiments, a character is familiar to the learner through use of the site. Many characters are suitable including, by way of non-limiting examples, persons, heroes, animals, and personified animals, plants, and objects. In some embodiments, a character suggests or recommends one or more particular learning activities to a learner via, for example, animation of the character gesturing, video of the character gesturing, audio of the character verbalizing, or an image (e.g., photograph, illustration, etc.) of the character gesturing or speaking by way of a speech bubble.

### Learner Data Pattern Analysis

In some embodiments educational system assembling platforms disclosed herein track and store learner data when a learner interacts with any aspect of the system. Many types of learner data are suitably tracked and stored. In various embodiments, suitable learner data includes, by way of non-limiting examples, data associated with historic learner performance (e.g., completion of learning activities, speed, accuracy, level of mastery, etc.), learner preferences (e.g., configured preference settings, previous selections, activity repetition, etc.), learner rewards earned (e.g., points, tickets, tokens, etc.), and the like. In view of the disclosure provided herein, those of skill in the art will recognize that many databases are suitable for storage and retrieval of learner data. In various embodiments, suitable databases include, by way of non-limiting examples, relational databases, non-relational databases, object oriented databases, object databases, entity-relationship model databases, associative databases, and XML databases. In some embodiments, a database of learner is internet-based. In further embodiments, a database of learner data is web-based. In still further embodiments, a database of learner data is cloud computing-based. In other embodiments, a database of learner data is based on one or more local computer storage devices.

In various embodiments, a software module configured to suggest or recommend one or more particular learning activities to a learner bases a suggestion or recommendation on one or more of a multitude of suitable data. In further embodiments, a software module configured to suggest or recommend one or more particular learning activities is configured to perform user pattern analysis to generate a suggestion or recommendation. In some embodiments, a software module configured to suggest or recommend one or more particular learning activities is configured to perform user pattern analysis on a learner's past performance in one or more subjects (e.g., areas of skill, interest, or expertise), levels, units, lessons, and/or learning activities.

In further embodiments, pattern analysis of performance includes analysis of data such as learner affinity, completion, speed, accuracy, level of mastery, and the like, in a subject, skill, or activity. In still further embodiments, level of mastery is assessed via learner scores in one or more subjects, skills, or activities. In still further embodiments, level of mastery is assessed via the number of rewards (e.g., points, tickets, tokens, etc.) that a learner has earned in one or more subjects, skills, or activities. In still further embodiments, level of mastery is assessed, for example, via the number of learning activities completed and/or the number of times a learner has participated in one or more activities. In some embodiments, a software module configured to suggest or recommend one or more particular learning activities is configured to perform user pattern analysis on a learner's past selections of learning activities. In some embodiments, a software module configured to suggest or recommend one or more particular learning activities is configured to perform user pattern analysis on a learner's configured preference settings.

For example, in a particular embodiment, a learner is presented with a group of five mathematics activities from which to select. In this embodiment, a software module configured to suggest or recommend one or more particular learning activities to a learner performs user analysis on a learner's past performance. The module records both a performance deficiency and a tendency to avoid selection of long division activities. In this embodiment, the software module configured to suggest or recommend one or more particular learning activities to a learner recommends a simple division activity to the learner via an animated character.

### Mentor Tuning

In various embodiments wherein a learner selects learning activities in which to participate and the educational system assembling platforms disclosed herein include a software module configured to suggest or recommend one or more particular learning activities to a learner, the platforms additionally comprise a software module configured to allow a mentor to view and tune data on which suggestions or recommendations are made. In this way, the guidance provided to a learner can also be fine tuned by a mentor through an interface that allows them to place more or less emphasis on particular skills, educational objectives, and/or learning activities.

In some embodiments, a software module configured to allow a mentor to view and tune data on which suggestions or recommendations are made provides a GUI, adapted for use by a mentor, to view a learner's past performance in one or more subjects (e.g., areas of skill, interest, or expertise), levels, units, lessons, and/or learning activities including data such as learner affinity, speed, accuracy, level of mastery, and the like, in a subject, skill, or activity. In some embodiments, a software module configured to allow a mentor to view and tune data on which suggestions or recommendations are made provides a GUI, adapted for use by a mentor, to view a learner's scores in one or more subjects, skills, or activities. In some embodiments, a software module configured to allow a mentor to view and tune data on which suggestions or recommendations are made provides a GUI, adapted for use by a mentor, to view a learner's rewards (e.g., points, tickets, tokens, etc.) earned in one or more subjects, skills, or activities. In some embodiments, a software module configured to allow a mentor to view and tune data on which suggestions or recommendations are made provides a GUI, adapted for use by a mentor, to view a learner's past selections of learning activities. In some embodiments, a software module configured to allow a mentor to view and tune data on which suggestions or recommendations are made provides a GUI, adapted for use by a mentor, to view a learner's configured preference settings.

In some embodiments, a software module configured to allow a mentor to view and tune data on which suggestions or recommendations are made provides a GUI, adapted for use by a mentor, to indicate which subjects, skills, educational objectives, and/or learning activities they would most like to see recommended or suggested to a learner. In further embodiments, a mentor indicates which subjects, skills, educational objectives, and/or learning activities they would most like to see a character or “site ambassador” emphasize for a learner.

In some embodiments, a mentor fine tunes suggestions or recommendations by rating or ranking subjects, skills, educational objectives, and/or learning activities. Many methods and interface elements are suitable for allowing a mentor to rate or rank subjects, skills, educational objectives, and/or learning activities. By way of non-limiting examples, a mentor makes ratings or rankings via radio buttons, check boxes, slider elements, drag and drop, and/or alphanumeric ranking. In some embodiments, a mentor rates or ranks subjects, skills, educational objectives, and/or learning activities on a scale of 1-100. In various further embodiments, a mentor rates or ranks subjects, skills, educational objectives, and/or learning activities on a scale of 1-10, 1-5, or 1-3. In some embodiments, a mentor rates or ranks subjects, skills, educational objectives, and/or learning activities on a scale including “more,” “same,” and “less.” In other embodiments, a mentor creates a relative rating or ranking of subjects, skills, educational objectives, and/or learning activities. For example, in a particular embodiment, each of five subjects available to a learner have their own 1-10 scale whereby a mentor who wishes the place a heavy emphasis on counting could rate that skill at 10 and could de-emphasize phonics by rating it at 3. After doing this, the system will assimilate this information from the mentor and guide learners accordingly.

### Monitoring the Progress of One or More Learners

In some embodiments, the educational system assembling platform disclosed herein further comprises a software module, adapted for use by a mentor, for monitoring the progress of one or more learners in completing one or more subpopulations of learning activities. In view of the disclosure provided herein, the software module is created by techniques known to those of skill in the art using machines, software, and languages known to the art. In further embodiments, the software module for monitoring the progress of one or more learners can be disabled by a mentor. In further embodiments, a mentor disables the software module in a settings configuration area of the educational system. In some embodiments, the software module monitors progress of one or more learners in subpopulations of activities representing learning activities within lessons. In some embodiments, the software module monitors progress of one or more learners in subpopulations of activities representing lessons within learning units. In some embodiments, the software module monitors progress of one or more learners in subpopulations of activities representing learning units within levels of study.

In some embodiments, the functionality of the software module for monitoring the progress of one or more learners in completing one or more subpopulations of learning activities is integrated into other software modules such as the module for selecting learning activities and/or the module for displaying and organizing subpopulations of activities. In some embodiments, the functionality of the software module for monitoring the progress of one or more learners in completing one or more subpopulations of learning activities is represented separately.

In some embodiments, the software module for monitoring the progress of a learner in completing one or more subpopulations of activities includes a visual indicator adapted for use by a learner, wherein said visual indicator displays the percentage of activities completed within a subpopulation of activities. In further embodiments, the visual indicator represents percentage of activities completed within a subpopulation of activities as, by way of non-limiting examples, a percentage, a bar chart, a pie chart, a color that changes in correlation with percentage, a shade that changes in correlation with percentage, dots, checkmarks, or size of an icon that changes in correlation with percentage.

In some embodiments, the software module for monitoring the progress of a learner in completing one or more subpopulations of activities includes progress displays adapted for use by a learner or a mentor to a learner. In some embodiments, the progress displays indicate percentage completion of one or more subpopulations of activities. In further embodiments, the progress displays indicate completion of one or more activities associated with each subpopulation of activities. In still further embodiments, the progress displays indicate the number of times a learner has completed one or more activities. In some embodiments, the progress displays indicate performance in one or more subpopulations of activities. In further embodiments, the progress displays indicate performance in one or more activities associated with each subpopulation of activities. In some embodiments, the progress displays indicate performance via, by way of non-limiting examples, raw scores or percentages. Some embodiments might also indicate performance by metrics such as grades. In some embodiments, the progress displays indicate time spent in one or more subpopulations of activities. In further embodiments, the progress displays indicate time spent in one or more activities associated with each subpopulation of activities. In still further embodiments, the progress displays indicate completion of one or more subpopulations of activities that teach to a particular educational objective, performance in one or more subpopulations of activities that teach to a particular educational objective, and time spent in one or more subpopulations of activities that teach to a particular educational objective. In still further embodiments, the progress displays indicate completion of one or more subpopulations of activities that address a particular element of a published educational standard, performance in one or more subpopulations of activities that address a particular element of an educational standard, and time spent in one or more subpopulations of activities that address a particular element of a published educational standard.

In some embodiments, the software module for monitoring the progress of a learner in completing one or more subpopulations of activities includes printable reports adapted for use by a learner or a mentor to a learner.

### Computer Network

In some embodiments, the methods, systems, platforms, and media disclosed herein include a digital processing device that it optionally connected to a computer network and a computer program that is provided to the device via the network. As used herein, a computer network means a collection of computers and/or devices interconnected by communications channels that facilitate communications among users and allow users to share resources. In view of the disclosure provided herein, a suitable computer network is created by techniques known to those of skill in the art using hardware, firmware, and software known to the art. In some embodiments, a computer network is a private network such as an intranet. In some embodiments, a computer network is the Internet. In further embodiments, the Internet provides access to the World Wide Web and an application is provided to a digital processing device via the Web. In still further embodiments, the Internet provides access to the World Wide Web and an application is provided to a digital processing device via cloud computing. In other embodiments, a computer network further comprises any suitable data storage device. Suitable data storage devices include, by way of non-limiting examples, CD-ROMs, DVDs, flash memory devices, magnetic disk drives, optical disk drives, cloud computing systems and services, and the like. In further embodiments, an application is provided to a digital processing device via a data storage device.

### Computer Program

In some embodiments, methods, systems, platforms, and media disclosed herein include at least one computer program executable by a digital processing device to create an educational environment. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity

### Software Modules

In some embodiments, the methods, systems, platforms, and media disclosed herein include software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Non-Transitory Computer Readable Storage Medium

In some embodiments, the methods, systems, platforms and media disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### EXAMPLES

The following illustrative examples are representative of embodiments of the educational system described herein and are not meant to be limiting in any way.

### Example 1

### Mentor Guided Learning Unit

An educational system assembling platform is constructed using a laptop computer connected to an intranet computer network and a computer program delivered to the computer via the network. The computer program includes executable instructions that create an educational environment. The educational environment includes approximately 550 learning activities teaching toward educational objectives in world history and includes a mentor guided learning mode. The mentor guided learning mode includes a software module for use by a mentor in selecting one or more learners, a software module for use by a mentor in selecting learning activities from among the population of learning activities to create one or more subpopulations of activities to be completed by a learner, and a software module for displaying one or more subpopulations of learning activities to a learner and providing access to them. The mentor guided learning mode also includes a software module for use by a mentor in further organizing subpopulations of learning activities and in monitoring the progress of a learner in completing each subpopulation of activities.

A secondary school teacher uses the educational system assembling platform to create a uniquely sequenced world history learning unit for a high school student. The teacher creates an account within the educational system and associates 105 students with her account. The teacher selects a single student and creates, names, and saves six lessons. She then uses keyword searching to identify learning activities teaching toward educational objectives related to the rise of the Roman Empire, the emperor Tiberius, the Battle of Alesia, the emperor Vespasian, the Roman Senate, and the decline of the Western Roman Empire. When she finds a relevant learning activity, she uses her computer mouse to click, drag, and drop an icon associated with the activity into a designated area to add it to the appropriate lesson. She populates each of the six lessons with five learning activities. She then further organizes each lesson by dragging and dropping the activity icons to sequence the activities within each lesson. She uses the same technique to further sequence the lessons within the unit. The student uses the educational system to view and participate in the activities in the sequence that his teacher created; however, the student finds a favorite activity on Vercingetorix, which he intermittently completes many times. Each day, the teacher uses a progress display to view which of the activities and lessons the student completes and how much time he spends on each.

### Example 2

### Mentor Guided, Branched, and Sequenced Set of Learning Units

An educational system assembling platform is constructed using a laptop computer connected to an intranet computer network and a computer program delivered to the computer via the network. The computer program includes executable instructions that create an educational environment. The educational environment includes approximately 400 learning activities teaching toward educational objectives in mathematics and includes a mentor guided learning mode. The mentor guided learning mode includes a software module for use by a mentor in selecting one or more learners, a software module for use by a mentor in selecting learning activities from among the population of learning activities to create one or more subpopulations of activities to be completed by a learner, and a software module for displaying one or more subpopulations of learning activities to a learner and providing access to them. The mentor guided learning mode also includes a software module for use by a mentor in further organizing subpopulations of learning activities and in monitoring the progress of a learner in completing each subpopulation of activities.

A middle school mathematics teacher uses the educational system assembling platform to create a branched, sequenced set of learning units for her 7th grade algebra class. She uses the learner selection function to select those of her students who scored less than 70% on the mid-term examination, and creates a subpopulation of activities organized into lessons and learning units for those students. In creating this subpopulation of activities, the teacher selects from the total population by filtering against specific educational objectives and published educational standards that were represented by questions on the examination that were most often missed. The teacher organizes the subpopulation of activities into a branched sequence of lessons, such that the exact path of individual students depends on their performance in certain of the activities. The final step in the sequence allows the learner to freely select learning activities from among a set of alternate activities.

As students move through this sequence, the teacher monitors progress according to the specific educational objectives of the activities as they are completed as well as the length of time required to complete activities. The teacher notices that activities which involve fractional coefficients seem to take much longer for roughly half of the students than comparable activities which do not address that specific educational objective. She then modifies the sequence so as to provide those specific students with activities that offer extra instruction and practice with regard to that objective, having selected such activities by filtering the entire population against that specific educational objective.

The educational system assembling platform also includes a software module configured to suggest or recommend one or more particular learning activities to a learner. As students progress to the final step in the sequence the software module configured to suggest or recommend particular learning activities performs a performance analysis for each student to identify the mathematical skill addressed by the sequence for which they scored the lowest. The module further generates an animated character to suggest, via animation and voice audio, that the student select a final activity that addresses their weakness.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. An educational system assembling platform comprising:
a. a digital processing device comprising a memory and an operating system configured to perform executable instructions;
b. a computer program, provided to the digital processing device, including executable instructions that create an educational environment, the educational environment comprising: at least one area of skill, interest, or expertise; a population of learning activities associated with each area of skill, interest, or expertise; and a guided learning mode comprising:
i. a software module configured to display and provide a learner access to one or more subpopulations of learning activities to be completed by a learner;
ii. a database of learner data in a computer memory;
iii. a software module configured to suggest or recommend one or more particular learning activities to a learner based on analysis of the learner data; and
iv. a software module configured to allow a mentor to view and tune learner data on which suggestions or recommendations are based.

2. The educational system assembling platform of claim 1, wherein the guided learning mode further comprises a software module, adapted for a mentor, for selecting one or more learners.

3. The educational system assembling platform of claim 2, wherein the software module configured to allow a mentor to view and tune learner data on which suggestions or recommendations are based allows a mentor to score, rate, or rank subjects, skills, educational objectives, or learning activities for suggestion or recommendation.

4. The educational system assembling platform of claim 2, wherein the guided learning mode further comprises a software module, adapted for a mentor, configured to allow selection of learning activities from among the population of activities to create one or more subpopulations of activities to be completed by a learner.

5. The educational system assembling platform of claim 1, wherein the software module configured to suggest or recommend one or more particular learning activities to a learner generates a character-based guide to make suggestions or recommendations.

6. The educational system assembling platform of claim 1, wherein the guided learning mode further comprises a software module configured to track and store learner data associated with learner interactions with the educational environment.

7. Non-transitory computer-readable storage media encoded with a computer program including instructions executable by a processor to create an educational system assembling platform, the platform comprising: at least one area of skill, interest, or expertise; a population of learning activities associated with each area of skill, interest, or expertise; and a guided learning mode comprising:
a. a software module configured to display and provide a learner access to one or more subpopulations of learning activities to be completed by a learner;
b. a database of learner data in a computer memory;
c. a software module configured to suggest or recommend one or more particular learning activities to a learner based on analysis of the learner data; and
d. a software module configured to allow a mentor to view and tune learner data on which suggestions or recommendations are based.

8. The media of claim 7, wherein the guided learning mode further comprises a software module, adapted for a mentor, for selecting one or more learners.

9. The media of claim 8, wherein the software module configured to allow a mentor to view and tune learner data on which suggestions or recommendations are based allows a mentor to score, rate, or rank subjects, skills, educational objectives, or learning activities for suggestion or recommendation.

10. The media of claim 8, wherein the guided learning mode further comprises a software module, adapted for a mentor, configured to allow selection of learning activities from among the population of activities to create one or more subpopulations of activities to be completed by a learner.

11. The media of claim 7, wherein the software module configured to suggest or recommend one or more particular learning activities to a learner generates a character-based guide to make suggestions or recommendations.

12. The media of claim 7, wherein the guided learning mode further comprises a software module configured to track and store learner data associated with learner interactions with the educational environment.

13. A computer-implemented method of educating a learner in a guided learning mode comprising the steps of:
a. providing, by a computer, a population of learning activities associated with an area of skill, interest, or expertise;
b. providing, by the computer, a software module configured to display and provide the learner access to one or more subpopulations of learning activities to be completed by the learner;
c. providing, by the computer, a database of learner data;
d. providing, by the computer, a software module configured to suggest or recommend one or more particular learning activities to a learner based on analysis of the learner data; and
e. providing, by the computer, a software module configured to allow a mentor to view and tune learner data on which suggestions or recommendations are based.

14. The method of claim 13, wherein the method further comprises the step of providing, by the computer, a software module, adapted for a mentor, for selecting one or more learners.

15. The method of claim 14, wherein the software module configured to allow a mentor to view and tune learner data on which suggestions or recommendations are based allows a mentor to score, rate, or rank subjects, skills, educational objectives, or learning activities for suggestion or recommendation.

16. The method of claim 14, wherein the method further comprises the step of providing, by the computer, a software module, adapted for a mentor, configured to allow selection of learning activities from among the population of activities to create one or more subpopulations of activities to be completed by a learner.

17. The method of claim 13, wherein the software module configured to suggest or recommend one or more particular learning activities to a learner generates a character-based guide to make suggestions or recommendations.

18. The method of claim 13, wherein the method further comprises the step of providing, by the computer, a software module configured to track and store learner data associated with learner interactions with the educational environment.
